(19) United States
(12) Patent Application Publication
(10) Pub. No.: US 2024/0175635 A1
(43) Pub. Date: May 30, 2024

(54) LIQUID COOLING DEVICE

(71) Applicant: DELTA ELECTRONICS, INC., Taoyuan City (TW)

(72) Inventors: Kuan-Cheng LU, Taoyuan City (TW); Chih-Hao HSIA, Taoyuan City (TW); Wei-Fang WU, Taoyuan City (TW); Meng-Yu CHEN, Taoyuan City (TW)

(21) Appl. No.: 18/519,414

(22) Filed: Nov. 27, 2023

(30) Foreign Application Priority Data
Nov. 29, 2022 (CN) 202211511685.7

(51) Int. Cl. F28D 1/03; F28D 1/06; F28F 9/00

(52) U.S. Cl. CPC F28D 1/0308; F28D 1/06; F28F 9/001; F28D 2020/0082

(57) ABSTRACT

This disclosure is directed to a liquid cooling device having at least two collecting tanks and at least one pair of heat-exchange plates. The tanks are separated from each other. Each of the collecting tanks has a joint tube. Each of the heat-exchange plates is in elongated shape and the collecting tanks are connected serially by the heat-exchange plates. The two collecting tanks are connected by the pair of heat-exchange plates. Each of the heat-exchange plates has a channel extended along the longitudinal direction thereof. The channels in the heat-exchange plates are connected to the collecting tanks at two ends of the heat-exchange plates, respectively. The longitudinal directions of the channels of the heat-exchange plates between the collecting tanks are parallel to each other.

### BACKGROUND OF THE DISCLOSURE

### Technical Field

This disclosure is directed to a liquid cooling device, and in particular to a liquid cooling device capable of contacting a heat source through multiple directions.

### Description of Related Art

The related-art batteries for an electric vehicle are electrically connected by a conductive copper bar, and a large amount of heat is accumulated at the conductive copper bar when the battery is discharged. A related-art method for heat dissipation is installing a water-cooling plate on the conductive copper busbar to remove the heat so as to maintain the copper bar at a normal operating temperature. According to the related-art art, two metal sheets or forgings disposed upper and lower are brazed with each other to form the water-cooling plate having a closed chamber therein. A fluid is circulated through a flow path defined in the closed chamber so that heat generated by the copper bar is removed by the fluid. However, the related-art water-cooling plate should be disposed parallelly to the conductive copper bar, and therefore the arrangements are limited.

In view of the above drawbacks, the inventor proposes this disclosure based on his expert knowledge and elaborate researches in order to solve the problems of related art.

### SUMMARY OF THE DISCLOSURE

This disclosure provides a liquid cooling device capable of contacting a heat source through multiple directions.

This disclosure is directed to a liquid cooling device having at least two collecting tanks and at least one pair of heat-exchanging plates. The collecting tanks are separated from each other and each of the collecting tanks has a joint tube. Each of the heat-exchanging plates is in an elongated shape, and the collecting tanks are connected serially by the heat-exchanging plates. The two collecting tanks are connected with each other by the pair of heat-exchanging plates, and each of the heat-exchanging plates has a channel disposed therein and extended along a longitudinal direction thereof. The channel in each of the heat-exchanging plates communicates with the two collecting tanks, and the collecting tanks are connected with two ends of the heat-exchanging plate, respectively. The heat-exchanging plates between the two collecting tanks are disposed side by side and non-parallelly to each other, and the channels of the respective heat-exchanging plates between the two collecting tanks are arranged longitudinally parallel to each other.

According to an embodiment of this disclosure, each of the collecting tanks has a main body and a cover, the cover is assembled on the main body, the joint tube is disposed on one of the main body and the cover, and another one of the main body and the cover is connected to the corresponding heat-exchanging plates. Each of the collecting tanks has a plurality of slots allowing the corresponding heat-exchanging plates to be inserted therein, respectively, and the slots are arranged non-parallelly to each other. Two of the slots may be arranged perpendicularly to each other. The two heat-exchanging plates may be arranged perpendicularly to each other.

According to an embodiment of this disclosure, each of the channels has a plurality of branch pipes extended along the longitudinal direction of the heat-exchanging plate, the branch pipes are disposed side by side, and two ends of each of the branch pipe are connected to the corresponding collecting tanks. The joint tube may be arranged parallelly to the longitudinal directions of the heat-exchanging plates. The joint tube may be arranged perpendicularly to the longitudinal directions of the heat-exchanging plates.

According to an embodiment of this disclosure, each of the heat-exchanging plates has a heat-exchanging surface. An inner included angle defined between the two heat-exchanging surfaces of the two heat-exchanging plates disposed side by side is less than 180 degrees.

This disclosure is directed to another liquid cooling device having a collecting tank and two pairs of heat-exchanging plates. The collecting tank has a joint tube. The two pairs of heat-exchanging plates are connected to two sides of the collecting tank, respectively, and each of the heat-exchanging plates is connected to the collecting tank via one end thereof. Each of the heat-exchanging plates has a channel disposed therein and extended along a longitudinal direction thereof, and the channels in the respective heat-exchanging plates communicate with the collecting tank. The two heat-exchanging plates of the pair of heat-exchanging plates are disposed side by side and non-parallelly to each other, and the channels of the pair of heat-exchanging plates are arranged longitudinally parallel to each other.

According to an embodiment of this disclosure, the collecting tank has a main body and a pair of covers, the pair of covers are assembled at two sides of the main body, the joint tube is arranged on the main body, and the covers are connected to the corresponding heat-exchanging plates.

Each of the covers has a pair of slots allowing the corresponding heat-exchanging plates to be inserted therein, respectively, and the pair of slots on each of the covers are arranged non-parallelly to each other. The pair of slots on each of the covers are arranged perpendicularly to each other.

According to an embodiment of this disclosure, the two heat-exchanging plates of each pair of heat-exchanging plates are arranged perpendicularly to each other.

According to an embodiment of this disclosure, each of the channels has a plurality of branch pipes extended along the longitudinal direction of the heat-exchanging plate, the branch pipes are disposed side by side, and the branch pipes are connected to the collecting tank, respectively.

According to an embodiment of this disclosure, the joint tube is arranged perpendicularly to the longitudinal directions of the heat-exchanging plates, respectively.

According to an embodiment of this disclosure, each of the heat-exchanging plates of at least one pair of heat-exchanging plates is connected to another collecting tank via another end thereof.

According to an embodiment of this disclosure, each of the heat-exchanging plates has a heat-exchanging surface, and an inner included angle defined between the two heat-exchanging surfaces of the two heat-exchanging plates disposed side by side is less than 180 degrees.

The liquid cooling device according to this disclosure has heat-exchanging plate be arranged side by side, and overall of the heat-exchanging plate be arranged non-parallelly to each other so that arrangements of the heat-exchanging surfaces of the liquid cooling device may have more feasibilities, and additional heat-exchanging plates may be arranged to the collecting tanks to extend the heat-exchanging surfaces.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective view showing a liquid cooling device according to a first embodiment of this disclosure;

FIG. 2 is an exploded view of the liquid cooling device according to the first embodiment of this disclosure;

FIG. 3 is a cross-sectional view on a longitudinal direction of the liquid cooling device according to the first embodiment of this disclosure at a-a cross-section shown in FIG. 1;

FIG. 4 is a cross-sectional view on a lateral direction of the liquid cooling device according to the first embodiment of this disclosure at b-b cross-section shown in FIG. 1;

FIG. 5 is a perspective view showing a variation of heat-exchanging plates of the liquid cooling device according to the first embodiment of this disclosure;

FIG. 6 is a perspective view showing a liquid cooling device according to a second embodiment of this disclosure;

FIG. 7 is an exploded view of the liquid cooling device according to the second embodiment of this disclosure;

FIG. 8 is a cross-sectional view on a lateral direction of the liquid cooling device according to the second embodiment of this disclosure at c-c cross-section shown in FIG. 6;

FIGS. 9 to 10 are schematic views showing various arrangements of the heat-exchanging plates of the liquid cooling device according to the second embodiment of this disclosure; and

FIG. 11 is a schematic view showing a using state of the liquid cooling device according to the second embodiment of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

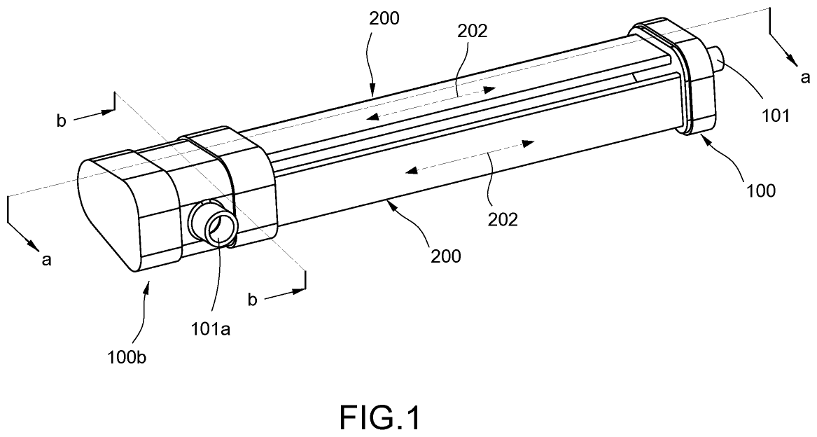

Referring to FIG. 1 which is a perspective view showing a liquid cooling device according to a first embodiment of this disclosure, and the first embodiment of this disclosure is directed to a liquid cooling device having two collecting tanks and a plurality of heat-exchanging plates 200. According to this embodiment, the two collecting tanks comprise a first collecting tank 100 and a second collecting tank 100b in different types. Each of the heat-exchanging plate 200 is substantially a rectangular plate, and a longitudinal direction 202 is defined. As shown in FIG. 1, the first collecting tank 100 and the second collecting tank 100b are connected serially by two heat-exchanging plates 200 at two ends thereof along the longitudinal directions 202. In other words, the collecting tank 100 is connected to one end of each of the two heat-exchanging plates 200, and the collecting tank 100b is connected to another end of each of the two heat-exchanging plates 200.

Also referring to FIG. 1, according to this embodiment, the liquid cooling device has the collecting tank 100 and the collecting tank 100b separated from each other. Each of the collecting tank has a joint tube. According to this embodiment, the joint tubes comprise a first joint tube 101 and a second joint tube 101a in two types, the first joint tube 101 is parallel to the longitudinal direction 202 of the heat-exchanging plate 200, and the second joint tube 101a is perpendicular to the longitudinal direction 202 of the heat-exchanging plate 200. The first collecting tank 100 has the first joint tube 101, and the second collecting tank 100b has the second joint tube 101a. The joint tubes communicate with inner spaces of the collecting tanks, respectively, so as to feed or drain a working fluid.

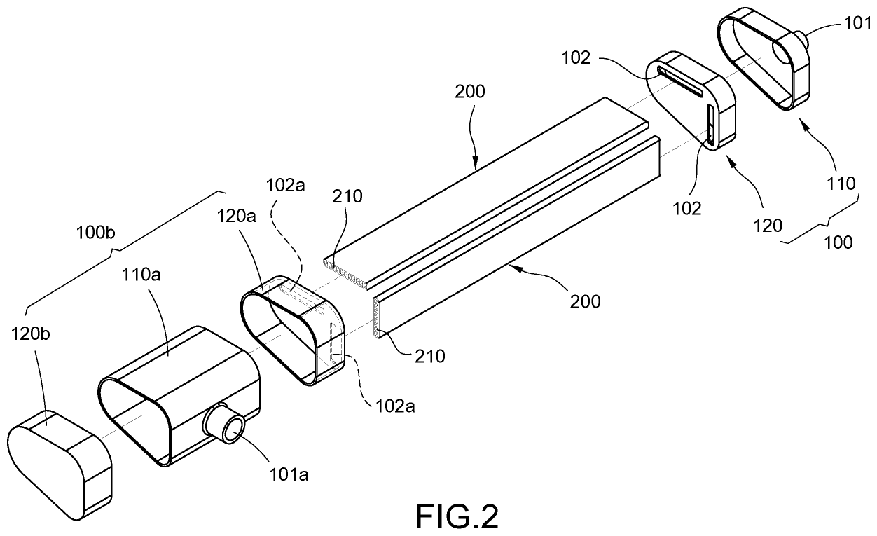

Referring to FIG. 2 which is an exploded view of the liquid cooling device according to the first embodiment of this disclosure, and each of the collecting tanks has a main body and at least one cover. Specifically, the respective collecting tanks may have main bodies and covers in various types. According to this embodiment, the first collecting tank 100 has a first main body 110 and a first cover 120. The second collecting tank 100b has a second main body 110a, and further has a second cover 120a and a third cover 120b connected to two sides of the main body 110a, respectively.

Also referring to FIG. 2, the first collecting tank 100 has a first main body 110 and a first cover 120. A first joint tube 101 is further arranged on the first main body 110. The first joint tube 101 and the first cover 120 of the first collecting tank 100 are disposed at two opposite sides of the first main body 110, respectively. The first cover 120 has slots 102 for further connecting with the two heat-exchanging plates 200, respectively. A number of the slots 102 is corresponding to that of the heat-exchanging plates 200 connected with the slots 102. As shown in FIG. 2, the first cover 120 has two slots 102 arranged non-parallelly to each other, and an included angle is defined between the two slots 102. According to this embodiment, the two slots 102 of the first cover 120 are perpendicular to each other so as to define a right angle between the two slots, but scopes of this disclosure should not be limited to this embodiment. Specifically, the first joint tube 101 is arranged on the first main body 110, and the first cover 120 is connected to the two heat-exchanging plates 200. According to this embodiment, the first collecting tank 100 has a space therein, and the structures could be integrally formed or formed in one piece according to manufacturing requirements.

Also referring to FIG. 2, the second collecting tank 100b has a second main body 110a, a second cover 120a and a third cover 120b. The second cover 120a has a plurality of slots 102a and the second cover 120a is connected to the aforementioned two heat-exchanging plates 200 via the slots 102a. According to this embodiment, the second cover 120a has two slots 102a arranged non-parallelly to each other, and an included angle is defined between the two slots 102a. According to this embodiment, the two slots 102a of the second cover 120a are perpendicular to each other, but scopes of this disclosure should not be limited to this embodiment. The main body 110a has one end connected to the second cover 120a and another end connected to the third cover 120b. In other words, the second cover 120a and the third cover 120b are disposed to cover two opposite sides of the second main body 110a, respectively. The second cover 120a is connected to the two heat-exchanging plates 200, and the third cover 120b is disposed for closing the main body 110. A second joint tube 101a is further arranged on the second main body 110a, the second joint tube 101a is perpendicular to the longitudinal direction 202 of the heat-exchanging plate 200 for allowing an additional expansion heat-exchanging plate (not shown in figures) to be optionally arranged on another side of the second main body 110a opposite to the aforementioned two heat-exchanging plates 200, but scopes of this disclosure should not be limited to this embodiment. According to this embodiment, the second collecting tank 100b has a space therein, and the structures may be integrally formed or formed in one piece according to manufacturing requirements.

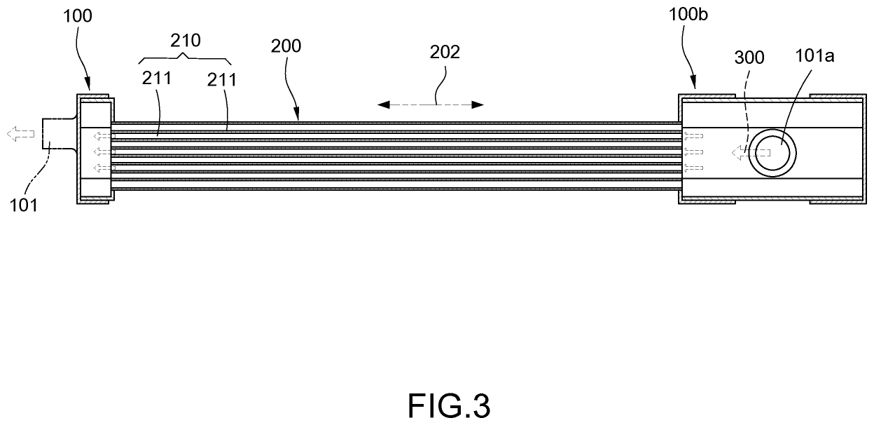

FIG. 3 is a cross-sectional view on a longitudinal direction of the liquid cooling device according to the first embodiment of this disclosure at a-a cross-section shown in FIG. 1. Referring to FIGS. 2 and 3, a channel 210 is defined in each of the heat-exchanging plates 200, each channel 210 is extended along a longitudinal direction 202 of the heat-exchanging plate 200 where the channel 210 is located. In each heat-exchanging plate 200, the channel 210 communicates with the collecting tanks at the two ends of the heat-exchanging plate 200, respectively. In other words, the channel 210 communicates with spaces defined by the two adjacent collecting tanks, the first collecting tank 100 and the second collecting tank 100b. The two heat-exchanging plates 200 are disposed side by side, and overall of the heat-exchanging plates 200 are disposed non-parallelly to each other, and longitudinal directions of the channels 210 of the heat-exchanging plates 200 are parallel to each other.

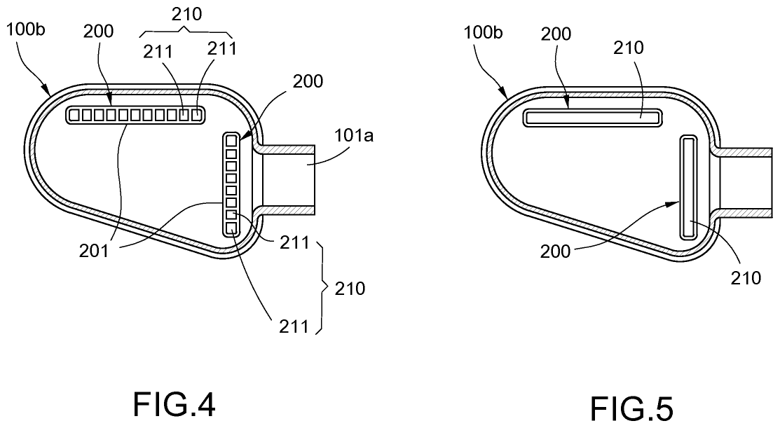

FIG. 4 is a cross-sectional view on a lateral direction of the liquid cooling device according to the first embodiment of this disclosure at b-b cross-section shown in FIG. 1. Referring to FIGS. 3 and 4, each of the heat-exchanging plates 200 has a heat-exchanging surface 201, an inner included angle defined between the two heat-exchanging surfaces 201 of the heat-exchanging plates 200 arranged side by side is less than 180 degrees. A right angle is defined between the two heat-exchanging surfaces 201 according to this embodiment. The heat-exchanging surfaces 201 of the heat-exchanging plates 200 are used for contacting a heat source such as a conductive copper bar applied on a battery. The conductive copper bar generally has a plurality of lateral surfaces, and the heat-exchanging surfaces 201 are capable of contacting the lateral surfaces of the conductive copper bar, respectively, to absorb heat from the heat source. Each channel 210 may has a plurality of branch pipes 211 disposed therein, each of the branch pipes 211 is extended along the longitudinal direction 202 of the heat-exchanging plate 200, the branch pipes 211 are arranged side by side, and each of the branch pipes 211 is connected to the corresponding collecting tanks via two ends thereof. According to this embodiment, each of the branch pipes 211 is connected to the first collecting tank 100 and the second collecting tank 100b via the two ends thereof. According to this embodiment, the working fluid 300 is fed into the liquid cooling device through the second joint tube 101a to passes through the respective channels 210 for thermal exchanging and then flows out from the liquid cooling device through the first joint tube 101, but a flow direction of the working fluid 300 in this disclosure should not be limited.

Referring to FIG. 5 which is a perspective view showing a variation of heat-exchanging plates 200 of the liquid cooling device according to the first embodiment of this disclosure, the channel 210 according to this disclosure should not be limited to the aforementioned embodiment, the channel 210 may be a single flat pipe. The heat-exchanging plate 200 shown in FIGS. 4 and 5 are made of a thermal conductive material such as copper or other alloys thereof and formed as one piece.

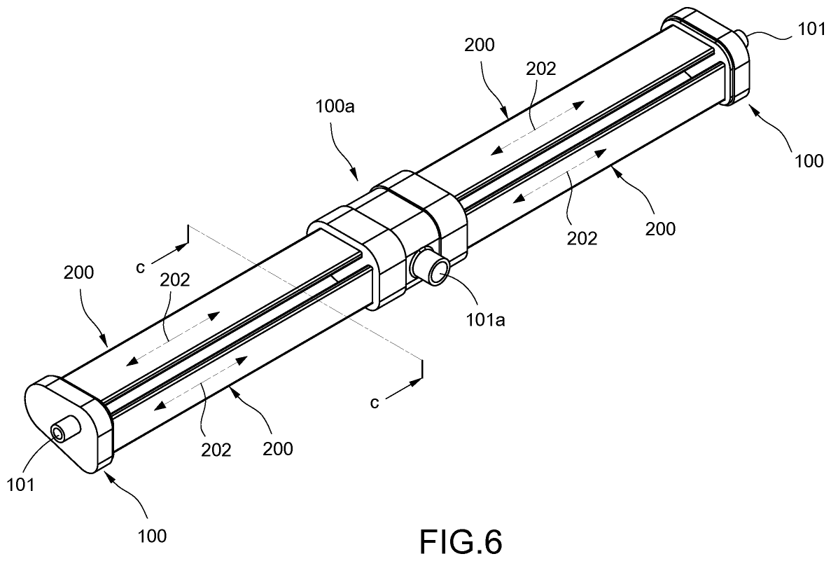

FIG. 6 is a perspective view showing a liquid cooling device according to a second embodiment of this disclosure. As shown in FIG. 6, the second embodiment of this disclosure is directed to a liquid cooling device having three collecting tanks and two pairs of heat-exchanging plates 200, the collecting tanks and the heat-exchanging plates 200 are connected in series. According to this embodiment, the three collecting tanks have two first collecting tanks 100 having structures mirroring with each other and a third collecting tank 100a. Each of the heat-exchanging plates 200 is substantially a rectangular plate, and a longitudinal direction 202 is defined. Each of the heat-exchanging plates 200 for one pair is connected to the third collecting tank 100a and one of the collecting tanks 100 via two ends thereof along the longitudinal direction 202. In other words, the third collecting tank 100a is connected to one end of one pair of the heat-exchanging plates 200 via one side thereof, and the third collecting tank 100a is connected to one end of another pair of heat-exchanging plates 200 via another side thereof.

Also referring to FIG. 6, the liquid cooling device has two first collecting tanks 100 and a third collecting tank 100a separated by the heat-exchanging plates 200. Each of the first collecting tanks 100 has a first joint tube 101, and the third collecting tank 100a has a second joint tube 101a. The first joint tube 101 is parallel to the longitudinal directions 202 of the heat-exchanging plates 200, the second joint tube 101a is perpendicular to the longitudinal directions 202 of the heat-exchanging plates 200.

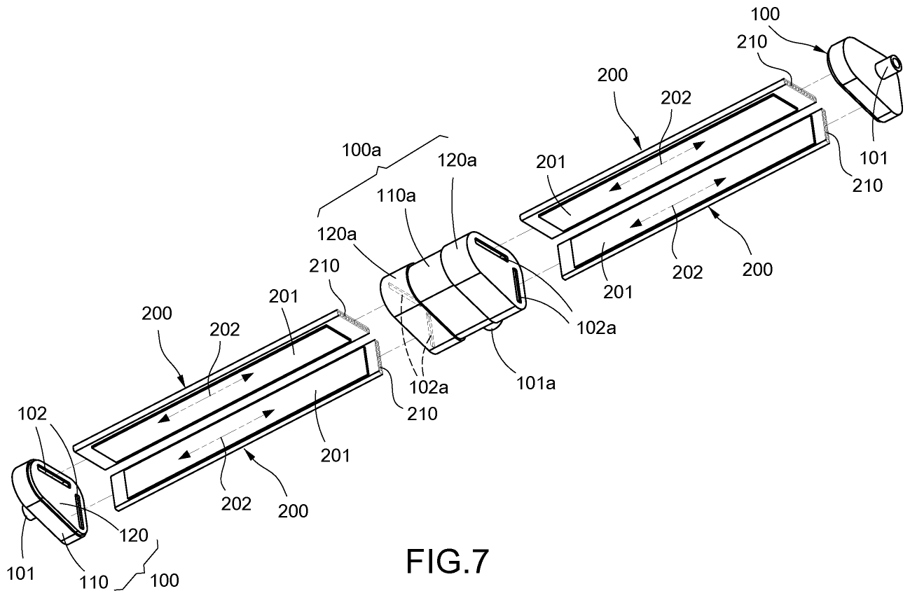

FIG. 7 is an exploded view of the liquid cooling device according to the second embodiment of this disclosure. Each of the collecting tanks has a main body and at least one cover. Specifically, the collecting tanks may have the main body and the cover in various types. According to this disclosure, each of the first collecting tanks 100 has a first main body 110 and a first cover 120. The third collecting tank 100a has a second main body 110a and two second covers 120a connected to two sides of the second main body 110a, respectively.

Also referring to FIG. 7, each of the first collecting tanks 100 at two ends of the liquid cooling device has a first main body 110 and a first cover 120. The first main body 110 further has a first joint tube 101, and the first joint tube 101 of the first collecting tank 100 and the cover 120 are connected to two opposite sides of the first main body 110, respectively. The first cover 120 has slots 102 for further connection to the corresponding heat-exchanging plates 200. The slots 102 have a number corresponding to that of the heat-exchanging plates 200 connected thereto. According to this embodiment, the first cover 120 has two slots 102 disposed non-parallelly to each other, and an included angle is defined between the two slots 102. According to this embodiment, the two slots 102 of the first cover 120 are perpendicular to each other, but scopes of this disclosure should not be limited to this embodiment. Specifically, the first joint tube 101 is arranged on the main body 110, and the first cover 120 is connected with the corresponding heat-exchanging plates 200, respectively. According to this embodiment, the structures of the first collecting tank 100 may be integrally formed or formed in one piece.

Also referring to FIG. 7, the third collecting tank 100a has a second main body 110a and two second covers 120a having structures mirroring with each other. Each of the second covers 120a has a plurality of slots 102a and each cover 120a is connected to the aforementioned heat-exchanging plates 200 via the slots 102a thereof, respectively. According to this embodiment, the second cover 120a has two slots 102a disposed non-parallelly to each other, and an included angle is defined between the two slots 102a. According to this embodiment, the two slots 102a of the second cover 120a are perpendicular to each other and a right angle is defined between the two slots 102a, but scopes of this disclosure should not be limited to this embodiment. Two ends of the second main body 110a are connected to the second covers 120a, respectively. In other words, the two covers 120a sheathe two opposite sides of the second main body 110a, respectively. The second main body 110a further has a second joint tube 101a, the second joint tube 101a is perpendicular to the longitudinal direction 202 of the heat-exchanging plate 200 to allow the heat-exchanging plates 200 to be disposed at two ends of the second main body 110a, respectively, but scopes of this disclosure should not be limited to this embodiment. According to this embodiment, the structures of the third collecting tank 100a may be integrally formed or formed in one piece.

According to FIG. 7, in each pair of heat-exchanging plates 200, the two heat-exchanging plates 200 are arranged side by side so that the longitudinal directions 202 of the respective heat-exchanging plates 200 are parallel to each other. In each pair of heat-exchanging plates 200, the channels 210 are extended along the longitudinal directions 202 of the heat-exchanging plate 200, respectively, and therefore parallel to each other. In each pair of heat-exchanging plates 200, the two heat-exchanging plates 200 are disposed side by side, and overall of the heat-exchanging plates 200 are disposed non-parallelly to each other, and the longitudinal directions of the channels 210 of the heat-exchanging plate 200 are parallel to each other. Each of the heat-exchanging plates 200 has a heat-exchanging surface 201. The heat-exchanging surface 201 of each heat-exchanging plate 200 is used for contacting a heat source such as a conductive copper bar applied on a battery. The conductive copper bar generally has a plurality of lateral surfaces, and the heat-exchanging surfaces 201 are capable of contacting the lateral surfaces of the conductive copper bar, respectively, to absorb heat from the heat source. In each pair of heat-exchanging plates 200, the two heat-exchanging plates 200 are disposed side by side and overall of the heat-exchanging plates 200 are disposed non-parallelly to each other, and an inner included angle between the two heat-exchanging surfaces 201 of the two heat-exchanging plates 200 arranged side by side is less than 180 degrees. In each pair of heat-exchanging plates 200 according to this embodiment, the two heat-exchanging plates 200 are perpendicular to each other to define a right angle between the two heat-exchanging plates 200, a right angle also defined between the two heat-exchanging surfaces 201 of the two heat-exchanging plates 200.

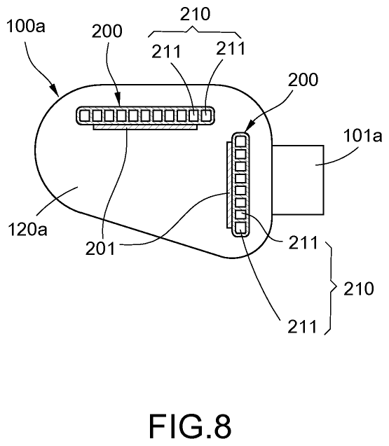

FIG. 8 is a cross-sectional view on a lateral direction of the liquid cooling device according to the second embodiment of this disclosure at c-c cross-section shown in FIG. 6. According to FIGS. 7 and 8, a channel 210 is defined in each heat-exchanging plate 200, the channel 210 is extended along the longitudinal direction 202 of the heat-exchanging plate 200. The channels 210 in the respective heat-exchanging plates 200 communicate with the third collecting tank 100a and communicate with the corresponding first collecting tanks 100, respectively, and the third collecting tank 100a is illustrated in FIG. 8.

Also referring to FIGS. 7 and 8, each of the channels 210 according to this embodiment has a plurality of branch pipes 211 extended along the longitudinal direction 202 of the heat-exchanging plate 200, the branch pipes 211 are disposed side by side, the branch pipes 211 are connected to the third collecting tank 100a, and the branch pipes 211 are further connected to the corresponding collecting tanks 100, respectively.

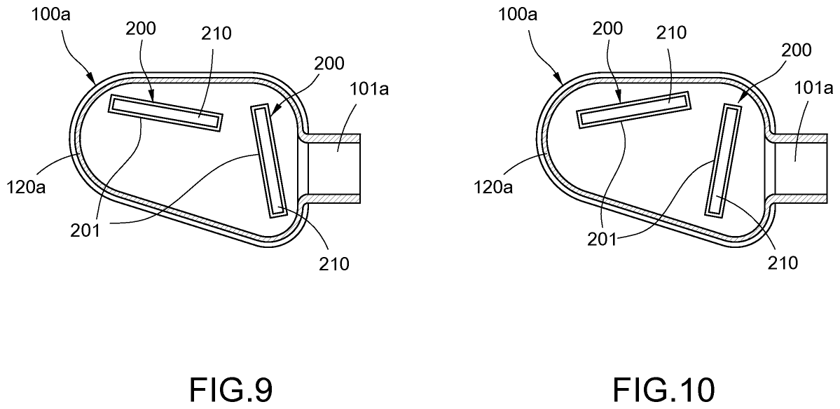

FIGS. 9 and 10 are schematic views showing various arrangements of the heat-exchanging plates of the liquid cooling device. The arrangement of the two heat-exchanging plates 200 of this disclosure should not be limited to the aforementioned embodiments, the two heat-exchanging plates 200 of this disclosure may be non-perpendicular to each other. According to FIG. 9, an inner included angle between the two heat-exchanging surfaces 201 of the two heat-exchanging plates 200 is an obtuse angle which is less than 180 degrees. An inner included angle between the two heat-exchanging surfaces 201 of the two heat-exchanging plates 200 according to FIG. 10 is an acute angle. Furthermore, the channel 210 illustrated in the figures of this disclosure should not be limited to the aforementioned embodiments, the channel 210, the channel 210 may be a single flat pipe.

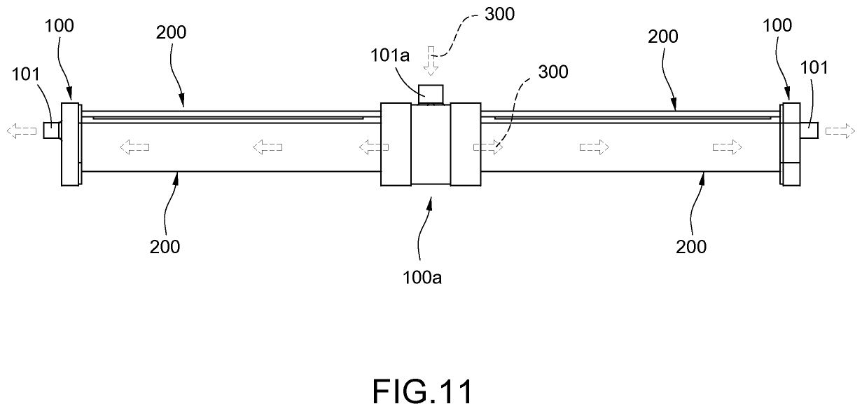

Referring to FIG. 11, which is a schematic view showing a using state of the liquid cooling device according to the second embodiment of this disclosure, the working fluid 300 may be fed into the liquid cooling device through the second joint tube 101a at a center of the liquid cooling device, the working fluid 300 is diverted from the third collecting tank 100a to the respective pairs of heat-exchanging plates 200 for heat exchanging and drained from two end of the liquid cooling device through the first joint tubes 101 on the first collecting tanks 100 at two sides of the liquid cooling device.

The liquid cooling device according to this disclosure has heat-exchanging plate be arranged side by side and overall of the heat-exchanging plates be disposed non-parallelly to each other so that arrangements of the heat-exchanging surfaces of the liquid cooling device have more feasibilities and may be disposed corresponding to various angle requirements by modifying the collecting tanks. Moreover, additional heat-exchanging plates may be arranged to the collecting tanks to extend the heat-exchanging surfaces. The collecting tank and the heat-exchanging plate may be easily assembled by sheathing and inserting.

While this disclosure has been described by means of specific embodiments, numerous modifications and variations could be made thereto by those skilled in the art without departing from the scope and spirit of this disclosure set forth in the claims.

What is claimed is:

1. A liquid cooling device, comprising:
at least two collecting tanks, spaced from each other, and each of the collecting tanks comprising a joint tube; and
at least one pair of heat-exchanging plates, each of the heat-exchanging plates being in an elongated shape, wherein the collecting tanks are connected serially by the heat-exchanging plates, and each of the heat-exchanging plates comprises a channel disposed therein and extended along a longitudinal direction thereof,
wherein the channel in each of the heat-exchanging plates communicates with the collecting tanks connected to two ends of the heat-exchanging plate, respectively, the heat-exchanging plates disposed between the two collecting tanks are arranged side by side and non-parallelly to each other, and the multiple channels of the heat-exchanging plates disposed between the two collecting tanks are arranged longitudinally parallel to each other.

2. The liquid cooling device according to claim 1, wherein each of the collecting tanks comprises a main body and a cover, the cover is assembled on the main body, the joint tube is disposed on one of the main body and the cover, and another one of the main body and the cover is connected to one of the heat-exchanging plates, correspondingly.

3. The liquid cooling device according to claim 2, wherein each of the collecting tanks comprises a plurality of slots for the heat-exchanging plates to be inserted correspondingly, and the slots are arranged non-parallelly to each other.

4. The liquid cooling device according to claim 3, wherein two of the slots are arranged perpendicularly to each other.

5. The liquid cooling device according to claim 1, wherein the two heat-exchanging plates are overall perpendicular to each other.

6. The liquid cooling device according to claim 1, wherein each of the channels comprises a plurality of branch pipes extended along the longitudinal direction of the heat-exchanging plate, the branch pipes are disposed side by side, and two ends of each of the branch pipes are connected to the collecting tanks correspondingly.

7. The liquid cooling device according to claim 1, wherein the joint tube is arranged parallelly to the longitudinal direction of each of the heat-exchanging plates.

8. The liquid cooling device according to claim 1, wherein the joint tube is arranged perpendicularly to the longitudinal direction of each of the heat-exchanging plates.

9. The liquid cooling device according to claim 1, wherein each of the heat-exchanging plates comprises a heat-exchanging surface, an inner included angle defined between two heat-exchanging surfaces of the two heat-exchanging plates disposed side by side is less than 180 degrees.

10. A liquid cooling device, comprising:
a collecting tank, comprising a joint tube; and
two pairs of heat-exchanging plates, connected to two sides of the collecting tank, respectively, one end of each the heat-exchanging plate connected to the collecting tank, each of the heat-exchanging plates comprising a channel disposed therein and extended along a longitudinal direction thereof, and the channel in each of the heat-exchanging plates communicating with the collecting tank,
wherein two heat-exchanging plates of each pair of heat-exchanging plates are disposed side by side and non-parallelly to each other, and multiple channels of each pair of heat-exchanging plates are arranged longitudinally parallel to each other.

11. The liquid cooling device according to claim 10, wherein the collecting tank comprises a main body and a pair of covers, the pair of covers are assembled at two sides of the main body, the joint tube is arranged on the main body, and the covers are connected to the heat-exchanging plates correspondingly.

12. The liquid cooling device according to claim 11, wherein each of the covers comprises a pair of slots for the heat-exchanging plates to be insert therein correspondingly, and the pair of slots on each of the covers are arranged non-parallelly to each other.

13. The liquid cooling device according to claim 12, wherein the pair of slots on each of the covers are arranged perpendicularly to each other.

14. The liquid cooling device according to claim 10, wherein the two heat-exchanging plates of each pair of heat-exchanging plates are arranged perpendicularly to each other.

15. The liquid cooling device according to claim 10, wherein each of the channels comprises a plurality of branch pipes extended along the longitudinal direction of each of the heat-exchanging plates, the branch pipes are disposed side by side, and each of the branch pipes is connected to the collecting tank.

16. The liquid cooling device according to claim 10, wherein the joint tube is arranged perpendicularly to the longitudinal direction of each of the heat-exchanging plates.

17. The liquid cooling device according to claim 10, wherein another end of each of the heat-exchanging plates of at least one pair of heat-exchanging plates is connected to another collecting tank.

18. The liquid cooling device according to claim 10, wherein each of the heat-exchanging plates comprises a heat-exchanging surface, and an inner included angle defined between two heat-exchanging surfaces of the two heat-exchanging plates disposed side by side is less than 180 degrees.
